(19) United States
(12) Patent Application Publication
(10) Pub. No.: US 2010/0161792 A1
(43) Pub. Date: Jun. 24, 2010

(54) Alternate media identification/selection based upon rendered media meta-data

(75) Inventors: Stephen Ray Palm, Irvine, CA (US); Jeyhan Karaoguz, Irvine, CA (US); Xuemin Chen, Rancho Santa Fe, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 12/343,587

(22) Filed: Dec. 24, 2008

(51) Int. Cl. G06F 15/173

(52) U.S. Cl. 709/224

(57) ABSTRACT

A technique to identify and characterize meta-data associated with an original content that is being transferred from a source to a renderer in a home network, in which the original content is to be rendered by the renderer. Instead of making available for rendering the original content, an alternate content for delivery to the renderer is located, wherein the alternate content is identified by associating the alternate content to the original content via characterization of the meta-data. Then, the alternate content is rendered instead of the original content or rendered in addition to the original content.

### BACKGROUND OF THE INVENTION

1. Technical Field of the Invention

The present invention relates generally to communication systems and, more particularly, to delivery of multimedia content across different platforms that are made interoperable through a network, such as a home network.

2. Description of Related Art

Content connectivity in a residence or office environment is becoming more attractive to simplify the way information is controlled and delivered. As more residences are built to accommodate a digital environment (digital home), the prior practice of having many different systems that operate independently from one another is undesirable for a number of reasons. In a typical home, a variety of electrical devices are present, but most of these devices operate independently from one another. For example, a television system that typically includes one or more displays, a digital video recorder (DVR) and/or a digital video disc (DVD) recorder/player, and which may also include a converter (generally known as a set-top box) may form one system. A television system in a home is typically connected together by a coaxial cable which runs through the home. Another system which may be present in a home is a telephone system, in which one or more telephone units are distributed throughout the house. A home telephone system may be wired or wireless or a combination of the two. Still another system typically found in a home is a computer system, in which one or more computers are connected to various peripherals, such as printers, cameras, compact disk (CD) or DVD players, mass storage units, routers, etc. Typically, various components of a home computer system are tied together by a router and/or a server through a wired local area network (LAN), a wireless LAN (WLAN) or a combination of both wired and wireless local area network, as well as other connectivity. Further, the home computer network is coupled to external networks, such as the Internet, through cable modem connections, DSL (Digital Subscriber Line) modem connections, telephone connections and/or microwave (e.g. satellite) connections, as well as other connections.

In an existing home, many of these systems operate independently from one another and complications are well noted in trying to bridge content from one system to another. For example, a digital photo may be readily transferred to a computer from a camera, so that a photo may be printed from a printer connected to the computer, but it is typically not possible to transfer the photo for display onto a television set. Likewise, a movie that may be played from a DVD player of a notebook computer may be watched on the notebook display, but that same movie cannot be watched on a television set in the home, unless the DVD is transferred to a DVD player connected to the television set or the notebook video output is connect to the television set.

More recently, a concept for an integrated digital home has emerged in order to tie together the various digital systems in a home. By developing an interoperable network to integrate both wired and wireless platforms, content may be delivered across these different platforms and shared seamlessly by devices coupled to the interoperable network. For example, personal computers (PCs), consumer electronics (CEs) and mobile devices, such as cellular telephones (cell phones), personal digital assistants (PDAs) and mobile multimedia devices (e.g. portable MP-3 players) may transfer content among themselves with minimal or no effort from the person wanting the content.

One entity which is attempting to form a cross-industry convergence of platforms is the Digital Living Network Alliance (DLNA). The various platforms, such as set-top boxes (STBs), PCs, DVD players, gaming machines, MP-3 players, Blue Ray™ players, mobile phones, personal media players, as well as others, may be integrated using one or more connectivity, such as multimedia over cable (MoCA) wired connection, Wi-Fi wireless connection, Ethernet wired LAN connection, Bluetooth wireless connection, Blue-Fi wireless connection, optical connectivity and powerline connectivity, as well as others. Once these various systems are tied together for seamless content sharing in a home network, content obtained from one platform may be transferred seamlessly to another platform using some form of connectivity.

Once the interoperable system is available in a home, the content to and/or from the various platforms may be manipulated in a variety of ways. This is possible, since a previously passive device, such as a television set, is now coupled to a processing device, such as a PC or a cell phone, so that additional computational power is now available to control content delivery to the passive device, or to other devices. Thus, new techniques to exploit this interoperability across platforms may be implemented to further control or enhance content delivery.

### SUMMARY OF THE INVENTION

The present invention is directed to apparatus and methods of operation that are further described in the following Brief Description of the Drawings, the Detailed Description of the Embodiments of the Invention, and the Claims. Other features and advantages of the present invention will become apparent from the following detailed description of the embodiments of the invention made with reference to the accompanying drawings.

### BRIEF DESCRIPTION OF THE DRAWINGS

FIG. 1 is a block diagram showing an exemplary home network system for implementing an embodiment of the invention.

FIG. 2 is a block diagram showing another exemplary home network system having multiple networks for implementing an embodiment of the invention.

FIG. 3 is a pictorial example illustration showing various home devices that are coupled together in a home network.

FIG. 4 is a block diagram showing a sourcing of one content and monitoring of meta-data associated with the content and selection of an alternate content based on the monitoring.

FIG. 5 is flow diagram to illustrate one technique of implementing the block diagram of FIG. 4.

FIG. 6 is a pictorial diagram showing a sourcing of a local content from a DVR or DVD device for rendering on a television set and selection of alternate content from a remote source for rendering on the television set.

FIG. 7 is a pictorial diagram showing a sourcing of a digital photo from a camera for printing on a printer and selection of additional content from another local content source also for printing by the printer.

### DETAILED DESCRIPTION OF THE EMBODIMENTS OF THE INVENTION

The embodiments of the present invention may be practiced in a variety of settings that utilize an integrated home network. The term “home network” is used herein for explanatory purpose only in order to simplify the description below. The invention is applicable to a variety of multimedia networks and the multimedia network need not be limited to a residence-based network. The described home-based network or “home network” may be implemented as a multimedia network in other types of buildings, both commercial and non-commercial, as well as across several sites that may not be contiguously connected.

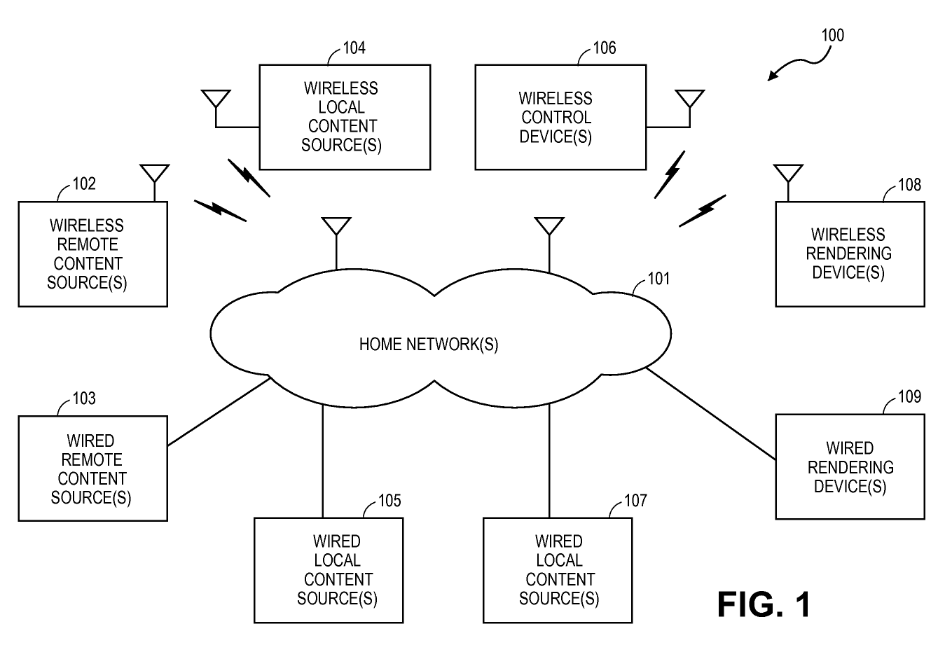

FIG. 1 shows a system 100 in which a variety of devices are coupled to a home network 101. Home network 101 may comprise one network or multiple networks, but for simplicity only the singular is used in the description of FIG. 1. Furthermore, as noted above, home network 101 may be any type of network that transports ordinary data, multimedia data or other information and need not be confined to a residence (e.g. home). The transfer of data may be serial, parallel, packet, non-packet, streaming, etc. The format may vary depending on the particular network or system. Home network 101 may be a wired network, wireless network or a combination of the two.

As shown in FIG. 1, a variety of wired and/or wireless devices are coupled to home network 101. FIG. 1 exemplifies the various devices that may couple to home network 101 and it is to be noted that some systems may have less devices coupled to the home network 101 than shown or more devices than shown. In the particular example, home network 101 may couple to one or more remote content source(s). The remote content source is usually located external to the “home” and is accessed by home network 101 through some communication pathway that connects to the remote content provider. In the shown example, home network 101 couples to one or more wireless remote content source(s) 102 through a wireless communication pathway, while home network 101 couples to one or more wired remote content source(s) 103 through a wired communication pathway.

As an example, one wireless remote content source may be a content provider of satellite programs where movies and television programming may be transmitted to home network 101 through satellite communication channels. A cellular telephone channel is another example in which content is provided to home network 101 by wireless means. An example of a wired connection to a wired remote content source is a cable link from home network 101 to a television programming provider, which may also provide movies for viewing. A wired Internet connection is another example, in which the wired connection of home network 101 to the Internet allows various content to be delivered from one or more remote source(s) to home network 101. Telephone land lines are another example of a wired connection that may be used. These are just some of the examples of remote content sources and the invention is not limited to the described examples.

Home network 101 may also couple to one or more wireless local content source(s) 104 and/or one or more wired local content source(s) 105. The local content sources 104, 105 may provide a variety of content and some of the content may be the same or similar to the content provided from remote content sources 102, 103. The difference is that the local content is sourced proximal to home network 101, so that external connection is not generally required to access the local content. An example of wired local content source 105 is a hard disk drive or a DVD/CD player of a personal computer (PC) or a server that couples to home network 101 by a LAN connection, such as an Ethernet connection. Another example of a wired local content source is a DVR device or a DVD player that couples to a television through home network 101. An example of wireless local content source 104 is a portable notebook computer that couples to home network 101 by wireless means, such as Wi-Fi, or Bluetooth™, or Blue-Fi. Another example of a wireless local content source is a cell phone or portable multimedia player that stores content (such as music) and has the capability to communicate with home network 101 to transfer content to home network 101. Again, these are examples only and should not be read to limit the invention. A variety of other local content sources, both wired and wireless, may be implemented for use with home network 101.

The content that is being transported on home network 101 from one or more of the sources 102-105 has a destination to which the content is rendered. Content is rendered when the content is made available to a renderer, which typically is a device that uses or operates on the delivered content. In the example of FIG. 1, home network 101 may be coupled to one or more wireless rendering device(s) 108 and/or wired rendering device(s) 109. Examples of wired rendering devices include, television displays, computer displays, audio speakers and headphones, wired printers, etc. Examples of wireless rendering devices include wirelessly connected printers, speakers, headsets, handheld displays, etc. These are just some examples of wired and wireless rendering devices and the invention is not limited to just these devices.

Also shown coupled to home network 101 are one or more wireless control device(s) 106 and or one or more wired controlled device(s) 107. It is to be noted that some processing intelligence is coupled to home network 101 to ensure proper operation of home network 101 in content delivery. In the example system 100, a wireless control device or a wired control device, or a combination of both, may provide operational control of portions or devices on home network 101. In some instances, one control device may provide full control of all content transport within home network 101 or the responsibility for content transfer may be divided among multiple units. Examples of control devices for either wireless control device(s) 106 or wired control device(s) 107 include, PCs, notebook computers, server computers, set-top boxes, handheld remotes and cell phones. These are just some examples and it is noted that other devices may be used as control devices as well.

System 100 is an illustrated example of a home network system in which contents are sourced, either locally or remotely, to one or more rendering devices. The various devices may communicate by wired or wireless means with home network 101. One or more control devices may be present to control home network 101 or control the transfer of the content from the content source to the rendering device (which is also referred to as a renderer herein). In some instances, a control device (such as control device 105, 106) may be part of (e.g. built into) the content source or the renderer. For example, when the content is stored in a computer, such as a PC, the PC may also serve as the control device. Likewise, if a set-top circuitry is built into a television set, then the television set may both be the renderer and the control device. Thus, system 100 is shown as an example only and other systems may be used to practice the invention.

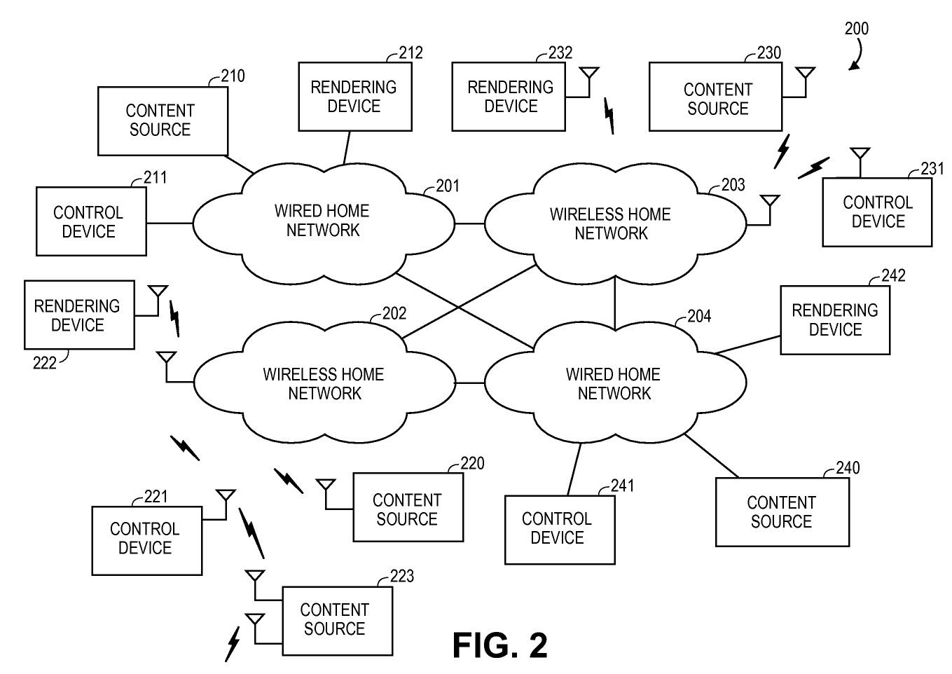

FIG. 2 is another example of a home network system 200 in which multiple home networks are present within a premise. Two home networks 201, 204 are wired while two home networks 202, 203 are wireless. The actual number and type (wired or wireless) of networks may vary from system to system. The four home networks 201-204 are inter-coupled so that in some embodiments, content may be transferred across networks. Content source 210, control device 211 and rendering device 212 are coupled to wired home network 201 by wired means. Likewise, content source 240, control device 241 and rendering device 242 are coupled to wired home network 204 by wired means. Content source 220, control device 221 and rendering device 222 are coupled to wireless home network 202 by wireless means. Likewise, content source 230, control device 231 and rendering device 232 are coupled to wireless home network 203 by wireless means. An additional content source 223 is shown also coupled to home network 202. As noted with system 100 of FIG. 1, some embodiments may not have all of the noted devices, while others may have more devices. What is to be noted is that various wired and/or wireless content source, rendering and control devices are coupled to a multi-network system.

The various devices that are coupled to the networks 201-204 operate equivalent to the respective devices noted for system 100 in FIG. 1. Thus, each content source 210, 220, 223, 230, 240 represents a remote content source, local content source, or both local and remote (as noted in FIG. 1). Content source 223 is shown having multiple antennas to indicate that multiple-input, multiple-output (MIMO) communication protocol may be used as well for wireless communications. The wired and/or wireless networks may be of the same platform or may be of different platforms. For example, in one embodiment, wired home network 201 may be a wired local area network (LAN), such as an Ethernet network, that allows computers to be coupled to various peripheral device; wireless home network 202 may be a Wi-Fi network within a premise, such as Wi-Fi that implements 802.11 a/b/g protocol or the 802.11n MIMO protocol; wireless home network 203 may be a Bluetooth™ or Blue-Fi network; and wired home network 204 may be a wired telephone network, a coaxial cable network (such as the afore-mentioned MoCA), optical network or a powerline network (such as the HomeGrid connectivity) that distributes audio, video and/or multimedia signals. In these instances, devices of corresponding platforms are coupled to a respective home network 201-204. Again, other embodiments may have different networks and connectivity. What is to be noted is that devices of different platforms may be coupled to corresponding networks and the networks are interoperably coupled together to operate as a home system. It is to be noted that some devices may have the capability to operate within more than one network. For example, a laptop or notebook computer may be coupled to various corresponding network by a wired LAN or coaxial connection, as well as having Wi-FI capability to connect wirelessly. The notebook computer may also have Bluetooth capability as well.

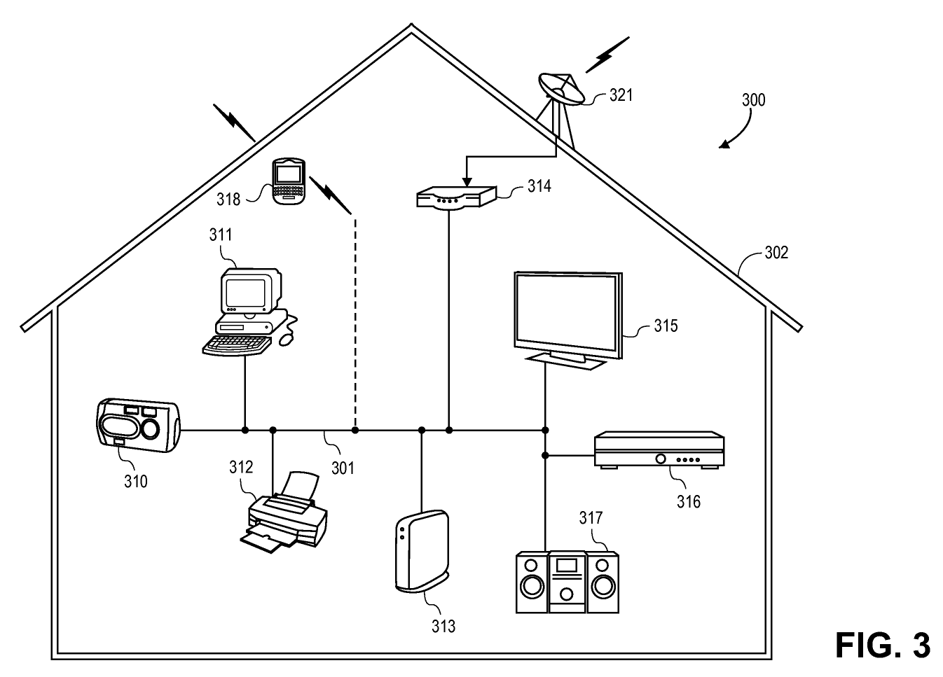

FIG. 3 shows an example of a home system 300 having a home network 301 within a premise 302, such as a home. Although a single communication path is shown for network 301, it is to be noted that the above-described examples of home network 101 or multiple home networks 201-204, as well as other embodiments using wired and/or wireless connectivity, may be employed for home network 301. Various devices 310-317 are also shown coupled to home network 301. Devices 310-317 exemplify different types of content source, control and rendering devices that may be found in a home environment. Although a line is shown coupling devices 310-317 to home network 301, it is understood that devices 310-317 represent devices that may operate wired, wireless or both, in accordance with the description of devices of FIGS. 1 and 2. Furthermore, devices 310-317 may operate within the same platform or may operate in different platforms, but made inter-operable by the home network or networks.

In the particular example of system 300, device 310 is a digital camera, device 311 is a desktop PC (or alternatively a notebook computer), device 312 is a printer, device 313 is a network storage medium, device 314 is a modem (or alternatively a set-top box), device 315 is a television display, device 316 is a DVR or DVD recorder/player, and device 317 is an audio recorder/player. These particular devices are presented here as an example only and, in other embodiments, different devices may be coupled to home network 301. As noted, modem 314 couples to a satellite dish 321 to reach a remote content source through satellite communication channels. Modem 314 could be a cable modem which communicates with a remote content source (such as a cable provider). Internet connection through modem 314 also allows system 300 to communicate with a remote content source through the Internet.

As noted above, some of the devices of system 300 may operate strictly in one capacity as a content source, control unit or renderer, while other devices may have multiple roles. For example, PC 311 may operate as a source when providing a PC stored content. It may also operate as a renderer when displaying photographs sent from camera 310, in which case camera 310 would be the source of the content. PC 311 may also operate as a control device in controlling the transfer of content from camera 310 to printer 312 for printing a photograph. In this instance, printer 312 would be the renderer. Again, in some embodiments, the control function may reside in the source or in the renderer, so that a separate control unit may not be needed.

FIG. 3 also shows a wireless device 318, such as a mobile telephone (e.g. a cellular telephone) or digital media device (or alternatively a remote control unit) that couples to home network 301. As a mobile telephone or digital media device, wireless device 318 may connect to a remote content source or as a remote control unit, may control the transfer of content from a source device to a rendering device. Device 318 may perform both functions as well.

In the particular example, the content that resides on the various devices or is loaded onto a device (such as by insertion of DVD or CD disks) are regarded as local content, since the content resides within premise 302. Content obtained remotely from sources external to premise 302 through pathways, such as satellite, microwave, cable or publicly switched telephone connection is regarded as remote content. In some instances, local content may have been previously obtained from a remote source as remote content and subsequently made available as local content. The described home network may operate within and/or be compatible with networks specified under the Digital Living Network Alliance (DLNA).

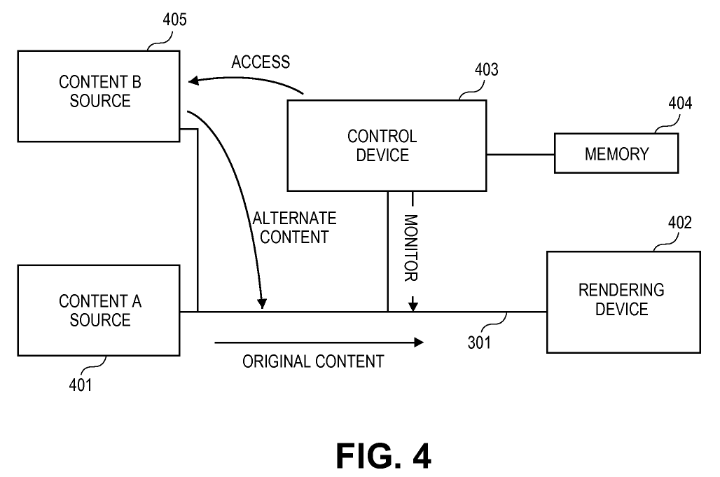

FIG. 4 illustrates how the various devices that communicate through home network 301 function within premise 302 in rendering a selected content. The example is applicable to the home network(s) of FIGS. 1 and 2 as well. In FIG. 4, content A is sourced from a content source 401 and communicated onto home network 301 to be rendered by rendering device 402. Content A may be selected by various means, but generally, the content is identified by a user for rendering to a particular rendering device selected by the user. For example, content A may be a photograph stored in a camera, in which the photograph is to be rendered on a video display for viewing or sent to a printer for printing. In another example, content A may be a movie on a DVD disc that is to be rendered on a television set. Content A may be local content or remote content.

Content A is selected from content source 401 and sent to a selected rendering device 402 on home network 301. A control device 403, equivalent to control devices described above in FIGS. 1-3, monitors the passage of content on home network 301. A variety of techniques may be used by control device 403 to monitor the content traffic on home network 301. Since much of the content that are used within a home environment includes meta-data to identify the content, in one embodiment control device 403 identifies the meta-data associated with the content traffic on home network 301 to characterize the content. For example, movies in digital format have meta-data that identifies the title of the movie, as well as other features associated with the movie. Similarly, audio content, such as songs and music, also have meta-data identifying the title and the artist. For home generated content, such as home videos or photographs, there is meta-data associated with each content. For example, a photograph in JPEG (Joint Photographic Experts Group) format may have an associated title (even if just a frame number) that operates as the meta-data to identify the particular content or may include meta-data as part of an EXIF (Exchangeable Image File) tag.

Control device 403, which may include a processor, monitors for the content traffic on home network 301 and when content traffic is noted, control device 403 characterizes the meta-data to identify the content. It is to be noted that control device 403 may have been the unit that initiated the transfer of content A to rendering device 402. Alternatively, another device may have initiated the content transfer and control device 403 is used to monitor the traffic on home network 301. Furthermore, although control device 403 is shown as a separate device, control device 403 may be part of or integrated into rendering device 402, or even in content source 401, in other embodiments.

Once control device 403 identifies and characterizes the meta-data associated with the original content A, control device 403 then actively seeks out an alternative content that may be accessed by home network 301 to render on rendering device 402. Control device 403 may perform the active search or direct other devices on home network 301 to perform the search. In the example of FIG. 4, control device 403 accesses content source 405 to identify that an alternate content B that is related to the original content A is present in content source 405. Control device 403 then makes content B available to rendering device 402 through home network 301.

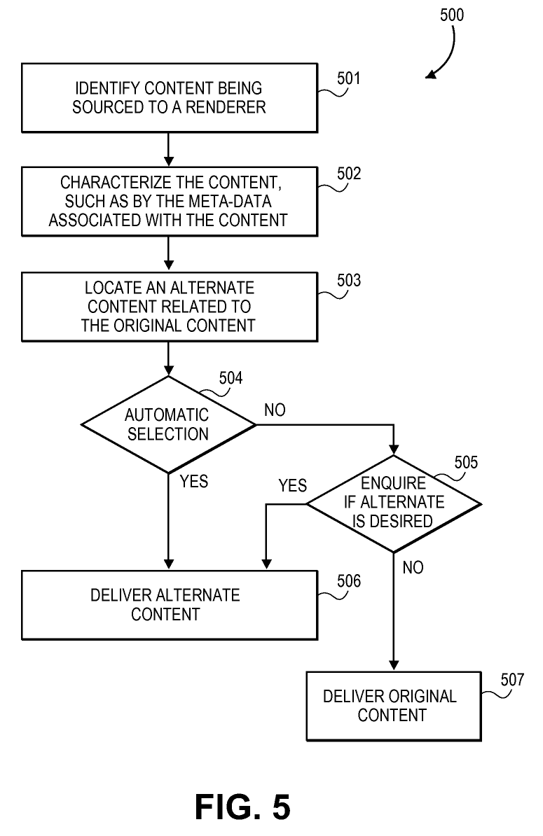

A variety of techniques may be implemented to have control device 403 monitor for transfer of content A to a renderer, identify and characterize the meta-data associated with the original content and search and select an alternate content that is related to the original content for rendering. In one embodiment, software that has program instructions to perform the above actions resides within control device 403 or in an associated memory 404 coupled to control device 403. The software may have been resident on a machine readable medium at one point and loaded into control device 403. A processor within control device 403 then executes program instructions of the software. In other embodiments, some or all of the software functions could be performed in hardware or firmware. What is to be noted is that once the original content is characterized, an alternate content is found and provided for rendering. The technique for achieving the task of alternate content selection is further illustrated in the flow diagram of FIG. 5.

In FIG. 5, process 500, which may be executed by the above-described software, identifies the original content (content A) being sourced to a renderer (block 501). The original content is then characterized, such as by the meta-data associated with the original content (block 502). Then, an alternate content related to the original content is located (block 503). In one embodiment of the invention, the processing intelligence determines if the located alternate content is to be delivered to the renderer. In that case, the selection is automatic (block 504) and the alternate content is delivered to the renderer. However, in other instances, it is desirable for the user to be given the choice. Information regarding the availability of the alternate content is provided to the user (block 505) and the user is given a choice to select the original content (block 507) or the alternate content (block 506) for delivery to the renderer.

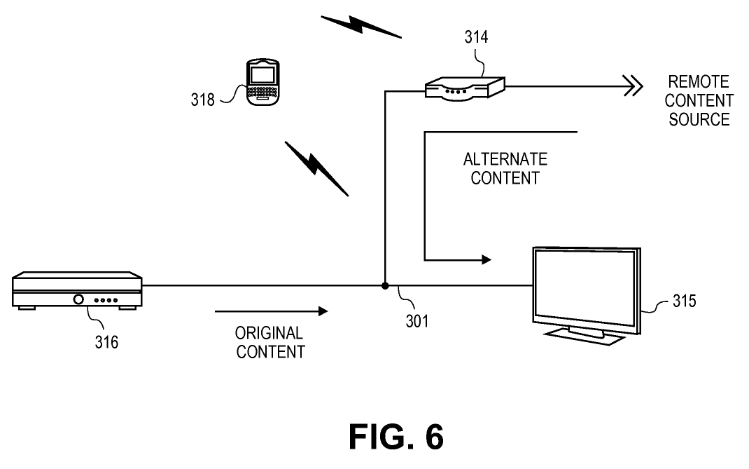

Many examples may be cited in which an alternate content is located and delivered to the renderer, instead of the original content. One example is illustrated in FIG. 6. In FIG. 6, an example is shown in which DVR or DVD device 316 contains a movie as a local content. The particular movie may have been pre-recorded as part of the programming to a DVR or a movie on a DVD disc is inserted in a DVD player for viewing. This original content (movie) is selected by a user for viewing onto a display, such as television set 315. The content is transferred on home network 301. Either prior to or during the transfer of the original content, a control device coupled to home network 301 monitors for content traffic. In the particular example, wireless device 318 (e.g. phone, digital media device, or digital remote) monitors the traffic and identifies the movie being sent to television set 315. After characterizing the meta-data associated with the movie, device 318 searches or have searches performed to locate an alternate content. In this example, set-top box 314 locates an alternate content at a remote source location. The alternate content from the remote location may now be rendered without user input or an option may be given to the user to select either the original content or the located alternate content.

In the above example, the original content was noted as a movie that is available as a local content. Further, in this example, the search to the remote content source location is a search to an on-line provider or to a television programming provider, which provides movies in different formats, such as in High-Definition (HD). The title of the movie may be searched for the same movie in a different format. If the original content is of standard definition, then the identification of the alternate content allows the user to view the same movie in HD. The control device 318 may or may not know if an enhanced version of the original content may be rendered. If control device 318 is able to ascertain the rendering properties of the renderer, then the enhanced version of the original content may be automatically displayed. If control device 318 is not able to discern the rendering properties of the renderer, then the user maybe given a choice for selection.

As noted above, the choice as to which version to render may be applied to all situations. For example, in the movie delivery example above, the providing of the enhanced version of the movie may be preceded by some selective criteria. In locating the availability of an enhanced (such as HD) version of the movie, the remote content provider may also provide a cost associated with delivering the enhanced movie. The user may then decide on which movie to be rendered based on the provided cost figure. As an additional example, if the selected rendering device is not capable of displaying the enhanced (e.g. HD) content, then the user may be given a choice so that the enhanced version could be viewed on another rendering device that is capable of displaying the enhanced version.

The movie delivery scenario described above is but one example for practicing an application of the present invention. The content need not be limited to movies or television programming. A similar scenario may be practiced for audio presentation. For example, enhanced version of the movie may be available in Hi-Fi stereo or in surround sound. The user may have a choice as to which, in conjunction with or separate from the selection of enhanced video.

Yet as another example, the original content may be a song stored on a storage media, such as a computer. When accessed for rendering on to a set of stereo speakers which are coupled to a stereo unit that couples to a home network, the control device monitoring the content traffic identifies the song title and searches for alternate content. For example, it may find that a digital audio player (e.g. MP-3 player) coupled to the home network contains a non-rated (or extended version) of the selected song. This alternate song may then be automatically rendered to the stereo speakers or the user given the choice as to which to play. If the alternate version is capable of being heard in surround sound, then the user may be given a choice to select surround sound speakers as an alternative rendering device. Note that in this instance, both songs were available as local content. In another example, remote content sources may be searched for alternate content. Thus, it is to be noted that various other scenarios may be practiced without departing from the spirit and scope of the present invention and that the examples provided herein are for understanding the invention and not to limit the invention.

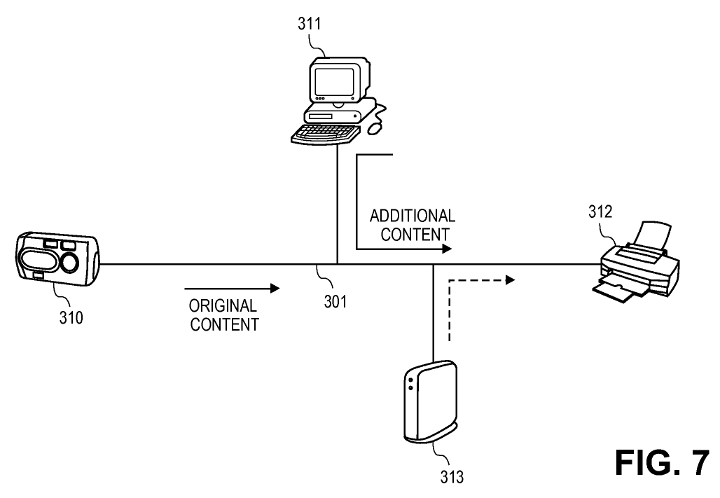

FIG. 7 illustrates another example in which alternate content is made available. In this example, digital camera 310 is coupled to home network 301 to transfer a photograph to printer 312 for printing. PC 311 is coupled to home network 301 and may or may not control the picture transfer. However, PC 311, if not initiating the transfer, monitors the original content delivery and characterizes the photograph. For example, the meta-data associated with the photograph may note that the title of the photograph is “wedding photo 0025.” The PC then may search the various content sources for similar title. In this example, PC 311 locates a number of “wedding photo ####” in mass storage medium 313. The PC then can notify the user that a number of additional content in way of additional “wedding photos” are available for rendering. The user may then select some, all or none of the additional content for printing. Thus, in rendering, the original content need not be replaced by the alternate content. Instead, the alternate content may be added to the original content. The various examples and scenarios described above are just some ways to practice the invention and other techniques, not mentioned, are available that fall within the spirit and scope of the invention.

Accordingly, an alternate media identification/selection based upon rendered media meta-data is described.

As may be used herein, the terms “substantially” and “approximately” provides an industry-accepted tolerance for its corresponding term and/or relativity between items. Such an industry-accepted tolerance ranges from less than one percent to fifty percent. Such relativity between items ranges from a difference of a few percent to magnitude differences. As may also be used herein, the term(s) “coupled” and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items.

Furthermore, as used herein, a processing device (or processor) may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions and such processing device may have accompanying memory.

Additionally, the term meta-data is used herein to describe other data associated with the content being sourced. Thus, such related or identifying data need not be formally identified as meta-data.

The embodiments of the present invention have been described above with the aid of functional building blocks illustrating the performance of certain functions. The boundaries of these functional building blocks have been arbitrarily defined for convenience of description. Alternate boundaries could be defined as long as the certain functions are appropriately performed. One of ordinary skill in the art may also recognize that the functional building blocks, and other illustrative blocks, modules and components herein, may be implemented as illustrated or by discrete components, application specific integrated circuits, processors executing appropriate software and the like or any combination thereof.

We claim:

1. A method comprising:
identifying and characterizing meta-data associated with an original content being transferred from a source to a renderer which is to render the original content in a home network;
locating an alternate content for delivery to the renderer, in which the alternate content is identified by associating the alternate content to the original content via characterization of the meta-data; and
making available for delivery the alternate content, instead of the original content, to the renderer.

2. The method of claim 1, wherein locating the alternate content includes locating an enhanced version of the original content and making available for delivery includes making available for delivery the enhanced version to the renderer.

3. The method of claim 1, further including delivering the alternate content by automatic selection once the alternate content is made available for delivery.

4. The method of claim 1, further including delivering the alternate content by user selection once the alternate content is made available to the user.

5. The method of claim 1, wherein locating the alternate content is performed by locating the alternate content within the home network.

6. The method of claim 1, wherein locating the alternate content is performed by locating the alternate content external to the home network.

7. The method of claim 6, wherein locating the alternate content external to the home network also identifies a cost associated with delivering the alternate content.

8. The method of claim 1, wherein making available for delivery includes making available the alternate content that is to be delivered to a visual display.

9. The method of claim 1, further including delivering the alternate content along with the original content to the renderer without replacing the original content.

10. The method of claim 1 further including:
characterizing properties of the alternate content; and
identifying a different renderer to deliver the alternate content based on the characterized properties of the alternate content.

11. An apparatus comprising:
a processor coupled to a home network to monitor content traffic on the home network when content from a source is transferred to a renderer to render the content; and
a memory coupled to the processor to store a program set of instructions which when executed by the processor causes the processor to identify and characterize meta-data associated with an original content being transferred from the source to the renderer to render the original content, locate an alternate content for delivery to the renderer, in which the alternate content is identified by associating the alternate content to the original content via characterization of the meta-data, and make available for delivery the alternate content, instead of the original content, to the renderer.

12. The apparatus of claim 11, wherein the apparatus is a server coupled to the home network.

13. The apparatus of claim 11, wherein the apparatus is included within the renderer.

14. The apparatus of claim 11, wherein the processor locates the alternate content that is an enhanced version of the original content and makes available for delivery the enhanced version as the alternate content to the renderer.

15. The apparatus of claim 11, wherein the processor automatically delivers the alternate content to the renderer once the alternate content is located.

16. The apparatus of claim 11, wherein the processor informs a user of the availability of the alternate content once the alternate content is located and delivers the alternate content to the renderer after user selection of the alternate content.

17. A machine-readable medium embodying a program of instructions thereon for execution by a machine, in which when the program is executed by the machine performs a process comprising:
identifying and characterizing meta-data associated with an original content being transferred from a source to a renderer which is to render the original content in a home network;
locating an alternate content for delivery to the renderer, in which the alternate content is identified by associating the alternate content to the original content via characterization of the meta-data; and
making available for delivery the alternate content, instead of the original content, to the renderer.

18. The machine-readable medium of claim 17, wherein when the executed process locates the alternate content, the alternate content is an enhanced version of the original content and the enhanced version is made available for delivery to the renderer.

19. The machine-readable medium of claim 17, wherein the executed process delivers the alternate content by automatic selection once the alternate content is located.

20. The machine-readable medium of claim 17, wherein the executed process delivers the alternate content by user selection once the alternate content is located.
